(19) United States
(12) Patent Application Publication
(10) Pub. No.: US 2025/0388094 A1
(43) Pub. Date: Dec. 25, 2025

(54) SYSTEMS AND METHODS TO IMPROVE DRIVABILITY IN A FUEL CELL ELECTRIC VEHICLE

(71) Applicant: CUMMINS INC., Columbus, IN (US)

(72) Inventors: Namit Singhai, Sacramento, CA (US); Akshat Joshi, Wembley (GB); Sumit Mishra, Sacramento, CA (US); Prateek Vaish, West Sacramento, CA (US); Yongfei Yu, Dublin, CA (US); Patrick Kaufman, Vacaville, CA (US); Yuanchun Cai, Davis, CA (US)

(21) Appl. No.: 18/753,897

(22) Filed: Jun. 25, 2024

(51) Int. Cl. B60L 15/20; B60L 15/10; B60L 58/40; H01M 10/42; H01M 16/00; H02J 7/00

(52) U.S. Cl. CPC B60L 15/2045; B60L 15/10; B60L 58/40; H01M 16/006; H02J 7/0048; H02J 7/005; B60L 2240/642; B60L 2240/68; H01M 2010/4271; H01M 2220/20; H01M 2250/20

(57) ABSTRACT

A fuel cell electric vehicle includes a fuel cell, a battery, and a power strategy control system communicatively coupled with the fuel cell and the battery. The power strategy control system is configured to maximize a power availability for the fuel cell electric vehicle to fulfill a vehicle power demand.

### TECHNICAL FIELD

The present disclosure relates to a power strategy control system for use in a fuel cell electric vehicle to maximize power availability for the fuel cell electric vehicle. The present disclosure relates to a variable regeneration control system for use in a fuel cell electric vehicle to selectively adjust an amount of power provided to at least one battery of the fuel cell electric vehicle by a motor of the fuel cell electric vehicle. The present disclosure also relates to a creep control system for use in a fuel cell electric vehicle to dynamically adjust an amount of torque provided to a motor of the fuel cell electric vehicle.

### BACKGROUND

Fuel cell systems are known for their efficient use of fuel to produce direct current electric energy to power mobile applications, such as, for example, vehicles, trains, buses, and trucks. Fuel cell electric vehicles may use a combination of fuel cells and batteries to provide power to a motor of the fuel cell electric vehicle. Controls of traditional fuel cell electric vehicles may not account for aggressive drive cycles.

For example, traditional control systems may determine fuel cell power set points using a rule-based algorithm. However, these traditional control systems often do not account for aggressive drive cycles and operator power demand, especially in cases of climbing up-hill grade conditions with full-load trailer conditions, as is often required in business commerce. Further, these traditional control systems do not account for traffic and/or road conditions that may vary during the drive cycle.

Therefore, it may be advantageous to provide systems that improve the controls of fuel cell electric vehicles such that the fuel cell electric vehicles can more appropriately operate during particularly demanding drive cycles. The present disclosure is directed to a power strategy control system, a variable regeneration control system, and a creep control system to help improve drivability and fuel economy of fuel cell electric vehicles with aggressive drive cycles.

### SUMMARY

Embodiments of the present disclosure are included to meet these and other needs.

According to a first aspect of the present disclosure, a fuel cell electric vehicle comprises at least one fuel cell, at least one battery, and a power strategy control system. The at least one fuel cell is configured to provide power for the fuel cell electric vehicle. The at least one battery is configured to provide power for the fuel cell electric vehicle. The power strategy control system is communicatively coupled with the at least one fuel cell and the at least one battery and configured to maximize a power availability for the fuel cell electric vehicle to fulfill a vehicle power demand. The power strategy control system is configured to determine a maximum fuel cell power from the at least one fuel cell and an optimized battery power from the at least one battery based, at least in part, on a battery discharge limit of the at least one battery, an accelerator pedal request, and drive conditions. The power strategy control system is configured to control operation of the at least one fuel cell to provide the maximum fuel cell power and the at least one battery to provide the optimized battery power so that the power availability for the fuel cell electric vehicle is maximized by the maximum fuel cell power while the at least one battery is protected from damage via the optimized battery power.

In some embodiments, the optimized battery power may be limited by the power strategy control system so that a state of health and a state of charge of the at least one battery are conserved so as to protect the at least one battery from damage. In some embodiments, the vehicle may further comprise a battery management system in communication with each of the at least one battery and the power strategy control system. In some embodiments, the battery management system may determine the battery discharge limit in real-time based on inputs from the at least one battery and the battery management system may communicate the battery discharge limit to the power strategy control system.

In some embodiments, the vehicle may further comprise a pedal sensor coupled with an accelerator pedal of the fuel cell electric vehicle. In some embodiments, the pedal sensor may be in communication with the power strategy control system to provide accelerator pedal request inputs to the power strategy control system based on an acceleration level of the fuel cell electric vehicle. In some embodiments, the drive conditions may include road grade and traffic. In some embodiments, the drive conditions may further include trailer conditions of the fuel cell electric vehicle.

In some embodiments, the power strategy control system may be in communication with at least one of a global positioning system and a sensor to receive the drive conditions therefrom. In some embodiments, the vehicle may further comprise a voltage sensor coupled with an accelerator pedal of the fuel cell electric vehicle. In some embodiments, the voltage sensor may be in communication with the power strategy control system to provide accelerator pedal request inputs to the power strategy control system based on an acceleration level of the fuel cell electric vehicle.

According to a further aspect of the present disclosure, a fuel cell electric vehicle comprises at least one fuel cell, at least one battery, and a power strategy control system. The at least one fuel cell is configured to provide power for the fuel cell electric vehicle. The at least one battery is configured to provide power for the fuel cell electric vehicle. The power strategy control system is communicatively coupled with the at least one fuel cell and the at least one battery and configured to maximize a power availability for the fuel cell electric vehicle to fulfill a vehicle power demand. The power strategy control system is configured to determine a maximum fuel cell power from the at least one fuel cell and an optimized battery power from the at least one battery based on a battery discharge limit of the at least one battery, an accelerator pedal request, and drive conditions.

In some embodiments, the optimized battery power may be limited by the power strategy control system so that a state of health and a state of charge of the at least one battery are conserved so as to protect the at least one battery from damage. In some embodiments, the vehicle may further comprise a battery management system in communication with each of the at least one battery and the power strategy control system. In some embodiments, the battery management system may determine the battery discharge limit in real-time based on inputs from the at least one battery and the battery management system communicates the battery discharge limit to the power strategy control system.

In some embodiments, the vehicle may further comprise a sensor coupled with an accelerator pedal of the fuel cell electric vehicle. In some embodiments, the sensor may be in communication with the power strategy control system to provide accelerator pedal request inputs to the power strategy control system based on an acceleration level of the fuel cell electric vehicle. In some embodiments, the drive conditions may include road grade and traffic.

In some embodiments, the power strategy control system may be in communication with at least one of a global positioning system and a sensor to receive the drive conditions therefrom.

According to a further aspect of the present disclosure, a method of maximizing a power availability for a fuel cell electric vehicle to fulfill a vehicle power demand comprises receiving a battery discharge limit from a battery management system based on at least one battery of the fuel cell electric vehicle. The method further comprises receiving an accelerator pedal request related to an acceleration level of the fuel cell electric vehicle. The method further comprises receiving drive conditions. The method further comprises, based on the battery discharge limit of the at least one battery, the accelerator pedal request, and the drive conditions, determining a maximum fuel cell power from at least one fuel cell and an optimized battery power from the at least one battery. The method further comprises controlling operation of the at least one fuel cell to provide the maximum fuel cell power to a motor of the fuel cell electric vehicle so that the power availability for the fuel cell electric vehicle is maximized by the maximum fuel cell power. The method further comprises controlling the at least one battery to provide the optimized battery power to the motor so that the at least one battery is protected from damage via the optimized battery power.

In some embodiments, the method may further comprise receiving a state of health and a state of charge of the at least one battery to determine the battery discharge limit. In some embodiments, the step of receiving an accelerator pedal request may include detecting voltage data related to the acceleration level of the fuel cell electric vehicle via a sensor coupled with an accelerator pedal.

In some embodiments, the drive conditions may include road grade and traffic. In some embodiments, the drive conditions may further include trailer conditions of the fuel cell electric vehicle. In some embodiments, the method may further comprise detecting the drive conditions via at least one of a global positioning system and a sensor.

### BRIEF DESCRIPTION OF THE DRAWINGS

FIG. 1A is a schematic view of an exemplary fuel cell system including an air delivery system, a hydrogen delivery system, and a fuel cell module including a stack of multiple fuel cells;

FIG. 1B is a cutaway view of an exemplary fuel cell system including an air delivery system, hydrogen delivery systems, and a plurality of fuel cell modules each including multiple fuel cell stacks;

FIG. 1C is a perspective view of an exemplary repeating unit of a fuel cell stack of the fuel cell system of FIG. 1A;

FIG. 1D is a cross-sectional view of an exemplary repeating unit of the fuel cell stack of FIG. 1C;

FIG. 2 is a diagrammatic view of a fuel cell electric vehicle having a power strategy control system;

FIG. 3 is a diagrammatic view of inputs and outputs to the power strategy control system of FIG. 2;

FIG. 4 is a diagrammatic view of the power strategy control system of FIGS. 2 and 3;

FIG. 5A is a graph showing frequency of power delivered using a traditional control system;

FIG. 5B is a graph showing frequency of power delivered using the power strategy control system of FIGS. 2 and 3;

FIG. 6 is a diagrammatic view of a fuel cell electric vehicle having a variable regeneration control system;

FIG. 7 is a view of an adjustable column of the variable regeneration control system of FIG. 6;

FIG. 8 is a diagrammatic view of a fuel cell electric vehicle having a creep control system;

FIG. 9 is a diagrammatic view of a process of the creep control system of FIG. 8;

FIG. 10 is a graph showing a non-corrected torque value as determined by the creep control system based on a vehicle speed;

FIG. 11 is a graph showing a correction torque value as determined by the creep control system based on an overspeed detection of the fuel cell electric vehicle; and

FIG. 12 is a diagrammatic view of the creep control system of FIGS. 8 and 9.

### DETAILED DESCRIPTION

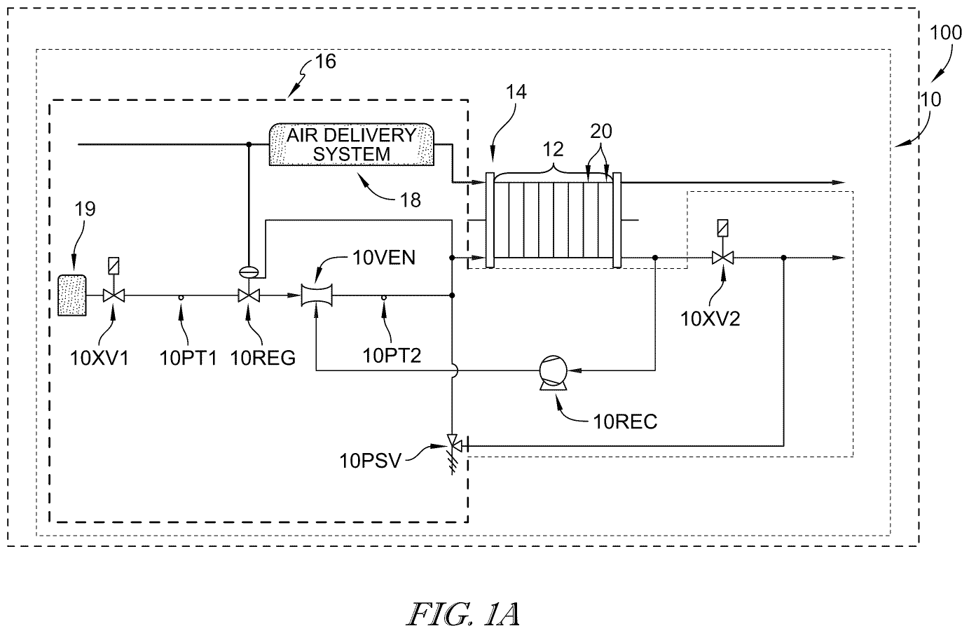

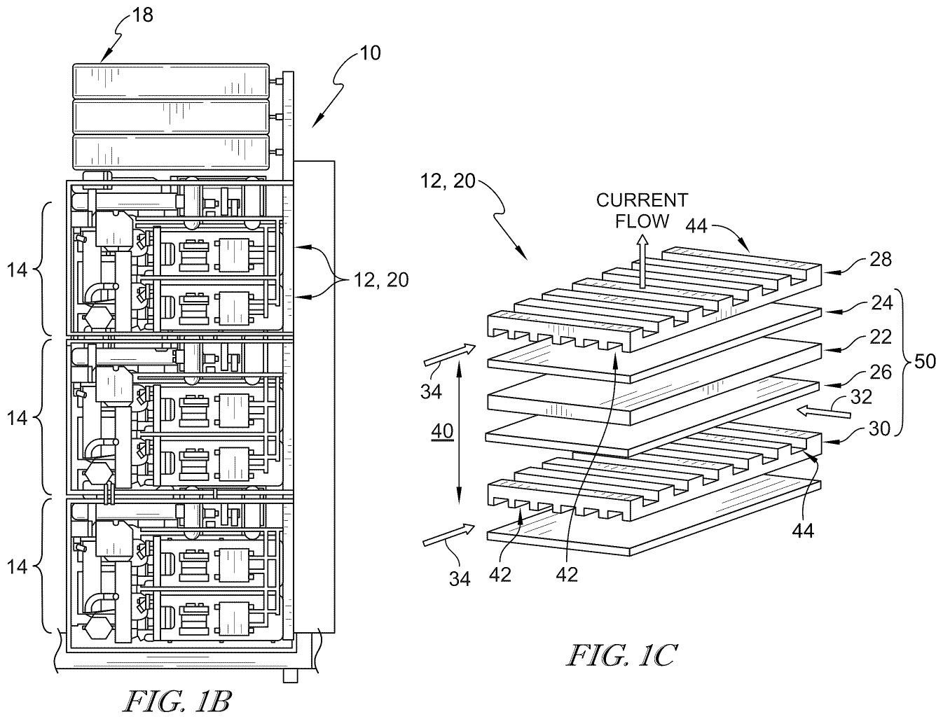

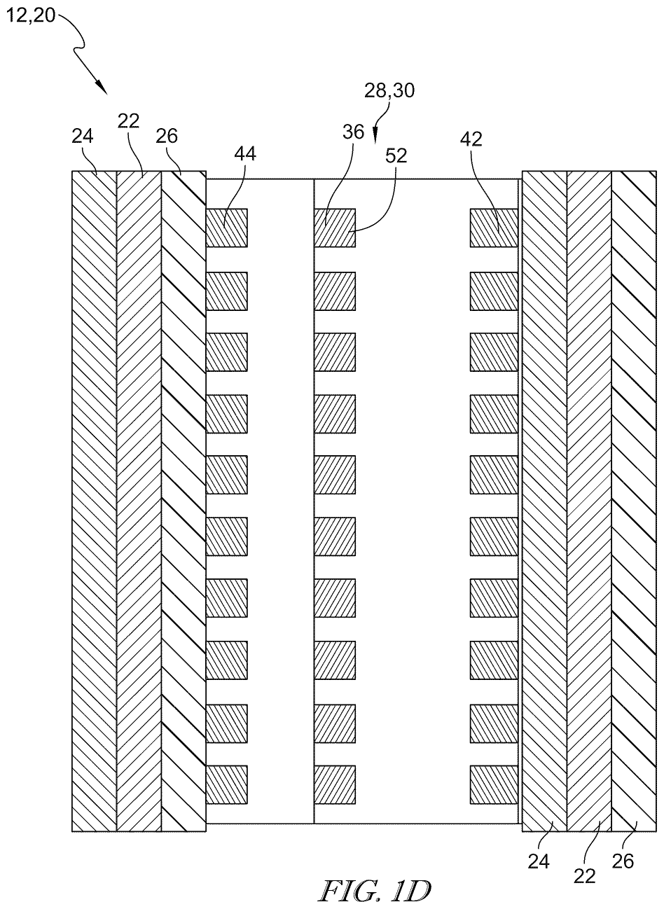

As shown in FIG. 1A, fuel cell systems 10 often include one or more fuel cell stacks 12 or fuel cell modules 14 connected to a balance of plant (BOP) 16, including various components, to support the electrochemical conversion, generation, and/or distribution of electrical power to help meet modern day industrial and commercial needs in an environmentally friendly way. As shown in FIGS. 1B and 1C, fuel cell systems 10 may include fuel cell stacks 12 comprising a plurality of individual fuel cells 20. Each fuel cell stack 12 may house a plurality of fuel cells 20 assembled together in series and/or in parallel. The fuel cell system 10 may include one or more fuel cell modules 14, as shown in FIGS. 1A and 1B. In some embodiments, the fuel cell system 10 may comprise one or more fuel cell stacks 12.

Each fuel cell module 14 may include a plurality of fuel cell stacks 12 and/or a plurality of fuel cells 20. The fuel cell module 14 may also include a suitable combination of associated structural elements, mechanical systems, hardware, firmware, and/or software that is employed to support the function and operation of the fuel cell module 14. Such items include, without limitation, piping, sensors, regulators, current collectors, seals, and insulators.

The fuel cells 20 in the fuel cell stacks 12 may be stacked together to multiply and increase the voltage output of a single fuel cell stack 12. The number of fuel cell stacks 12 in a fuel cell system 10 can vary depending on the amount of power required to operate the fuel cell system 10 and meet the power need of any load. The number of fuel cells 20 in a fuel cell stack 12 can vary depending on the amount of power required to operate the fuel cell system 10 including the fuel cell stacks 12.

The number of fuel cells 20 in each fuel cell stack 12 or fuel cell system 10 can be any number. For example, the number of fuel cells 20 in each fuel cell stack 12 may range from about 100 fuel cells to about 1000 fuel cells, including any specific number or range of number of fuel cells 20 comprised therein (e.g., about 200 to about 800). In an embodiment, the fuel cell system 10 may include about 20 to about 1000 fuel cells stacks 12, including any specific number or range of number of fuel cell stacks 12 comprised therein (e.g., about 200 to about 800). The fuel cells 20 in the fuel cell stacks 12 within the fuel cell module 14 may be oriented in any direction to optimize the operational efficiency and functionality of the fuel cell system 10.

The fuel cells 20 in the fuel cell stacks 12 may be any type of fuel cell 20. The fuel cell 20 may be a polymer electrolyte membrane or proton exchange membrane (PEM) fuel cell, an anion exchange membrane fuel cell (AEMFC), an alkaline fuel cell (AFC), a molten carbonate fuel cell (MCFC), a direct methanol fuel cell (DMFC), a regenerative fuel cell (RFC), a phosphoric acid fuel cell (PAFC), or a solid oxide fuel cell (SOFC). In an exemplary embodiment, the fuel cells 20 may be a polymer electrolyte membrane or proton exchange membrane (PEM) fuel cell or a solid oxide fuel cell (SOFC).

In an embodiment shown in FIG. 1C, the fuel cell stack 12 includes a plurality of proton exchange membrane (PEM) fuel cells 20. Each fuel cell 20 includes a single membrane electrode assembly (MEA) 22 and a gas diffusion layers (GDL) 24, 26 on either or both sides of the membrane electrode assembly (MEA) 22 (see FIG. 1C). The fuel cell 20 further includes a bipolar plate (BPP) 28, 30 on the external side of each gas diffusion layers (GDL) 24, 26, as shown in FIG. 1C. The above-mentioned components, in particular the bipolar plate 30, the gas diffusion layer (GDL) 26, the membrane electrode assembly (MEA) 22, and the gas diffusion layer (GDL) 24 comprise a single repeating unit 50.

The bipolar plates (BPP) 28, 30 are responsible for the transport of reactants, such as fuel 32 (e.g., hydrogen) or oxidant 34 (e.g., oxygen, air), and cooling liquid 36 (e.g., coolant and/or water) in a fuel cell 20. The bipolar plates (BPP) 28, 30 can uniformly distribute reactants 32, 34 to an active area 40 of each fuel cell 20 through oxidant flow fields 42 and/or fuel flow fields 44 formed on outer surfaces of the bipolar plates (BPP) 28, 30. The active area 40, where the electrochemical reactions occur to generate electrical power produced by the fuel cell 20, is centered, when viewing the stack 12 from a top-down perspective, within the membrane electrode assembly (MEA) 22, the gas diffusion layers (GDL) 24, 26, and the bipolar plate (BPP) 28, 30.

The bipolar plates (BPP) 28, 30 may each be formed to have reactant flow fields 42, 44 formed on opposing outer surfaces of the bipolar plate (BPP) 28, 30, and formed to have coolant flow fields 52 located within the bipolar plate (BPP) 28, 30, as shown in FIG. 1D. For example, the bipolar plate (BPP) 28, 30 can include fuel flow fields 44 for transfer of fuel 32 on one side of the plate 28, 30 for interaction with the gas diffusion layer (GDL) 26. The bipolar plate (BPP) 28, 30 also includes oxidant flow fields 42 for transfer of oxidant 34 on the second, opposite side of the plate 28, 30 for interaction with the gas diffusion layer (GDL) 24.

As shown in FIG. 1D, the bipolar plates (BPP) 28, 30 can further include coolant flow fields 52 formed within the plate (BPP) 28, 30, generally centrally between the opposing outer surfaces of the plate (BPP) 28, 30. The coolant flow fields 52 facilitate the flow of cooling liquid 36 through the bipolar plate (BPP) 28, 30 in order to regulate the temperature of the plate (BPP) 28, 30 materials and the reactants. The bipolar plates (BPP) 28, 30 are compressed against adjacent gas diffusion layers (GDL) 24, 26 to isolate and/or seal one or more reactants 32, 34 within their respective pathways 44, 42 to maintain electrical conductivity, which is required for robust operation of the fuel cell 20 (see FIGS. 1C and 1D).

The fuel cell system 10 described herein may be used in stationary and/or immovable power system, such as industrial applications and power generation plants. The fuel cell system 10 may also be implemented in conjunction with an air delivery system 18. Additionally, the fuel cell system 10 may also be implemented in conjunction with a hydrogen delivery system and/or a source of hydrogen 19 such as a pressurized tank, including a gaseous pressurized tank, cryogenic liquid storage tank, chemical storage, physical storage, stationary storage, an electrolysis system or an electrolyzer. In one embodiment, the fuel cell system 10 is connected and/or attached in series or parallel to a hydrogen delivery system and/or a source of hydrogen 19, such as one or more hydrogen delivery systems and/or sources of hydrogen 19 in the BOP 16 (see FIG. 1A). In another embodiment, the fuel cell system 10 is not connected and/or attached in series or parallel to a hydrogen delivery system and/or a source of hydrogen 19.

In some embodiments, the fuel cell system 10 may include an on/off valve 10XV1, a pressure transducer 10PT1, a mechanical regulator 10REG, and a venturi 10VEN arranged in operable communication with each other and downstream of the hydrogen delivery system and/or source of hydrogen 19, as shown in FIG. 1A. The pressure transducer 10PT1 may be arranged between the on/off valve 10XV1 and the mechanical regulator 10REG. In some embodiments, a proportional control valve may be utilized instead of a mechanical regulator 10REG. In some embodiments, a second pressure transducer 10PT2 is arranged downstream of the venturi 10VEN, which is downstream of the mechanical regulator 10REG.

In some embodiments, the fuel cell system 10 may further include a recirculation pump 10REC downstream of the stack 12 and operably connected to the venturi 10VEN. The fuel cell system 10 may also include a further on/off valve 10XV2 downstream of the stack 12, and a pressure transfer valve 10PSV, as shown in FIG. 1A.

The present fuel cell system 10 may also be comprised in mobile applications. In an exemplary embodiment, the fuel cell system 10 is in a vehicle and/or a powertrain 100. A vehicle 100 comprising the present fuel cell system 10 may be an automobile, a pass car, a bus, a truck, a train, a locomotive, an aircraft, a light duty vehicle, a medium duty vehicle, or a heavy-duty vehicle. Types of vehicles 100 can also include, but are not limited to commercial vehicles and engines, trains, trolleys, trams, planes, buses, ships, boats, and other known vehicles, as well as other machinery and/or manufacturing devices, equipment, installations, among others.

The vehicle and/or a powertrain 100 may be used on roadways, highways, railways, airways, and/or waterways. The vehicle 100 may be used in applications including but not limited to off highway transit, bobtails, and/or mining equipment. For example, an exemplary embodiment of mining equipment vehicle 100 is a mining truck or a mine haul truck.

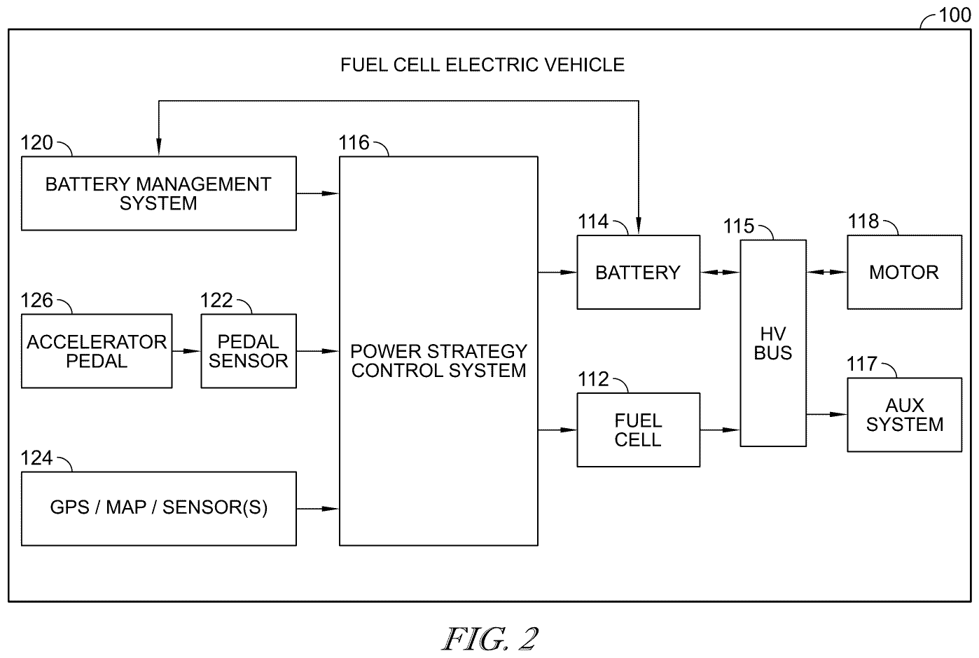

In illustrative embodiments, the vehicle 100 is a fuel cell electric vehicle (FCEV) 100. The present disclosure provides a power strategy control system 116 for use in the FCEV 100, as shown in FIG. 2. The FCEV 100 includes at least one fuel cell 112, at least one battery 114, and the power strategy control system 116. The fuel cell 112 may be the fuel cell 20 described above.

The FCEV 100 has two main power sources, including the at least one fuel cell 112 and the at least one battery 114. The fuel cell 112 and the battery 114 provide power to a high voltage bus 115 of the FCEV 100, which provides power to a motor 118 of the FCEV 100 and an auxiliary system 117 of the FCEV 100, as demonstrated in FIG. 2. The fuel cell 112 is configured to charge the battery 114 during different operating states of the FCEV 100.

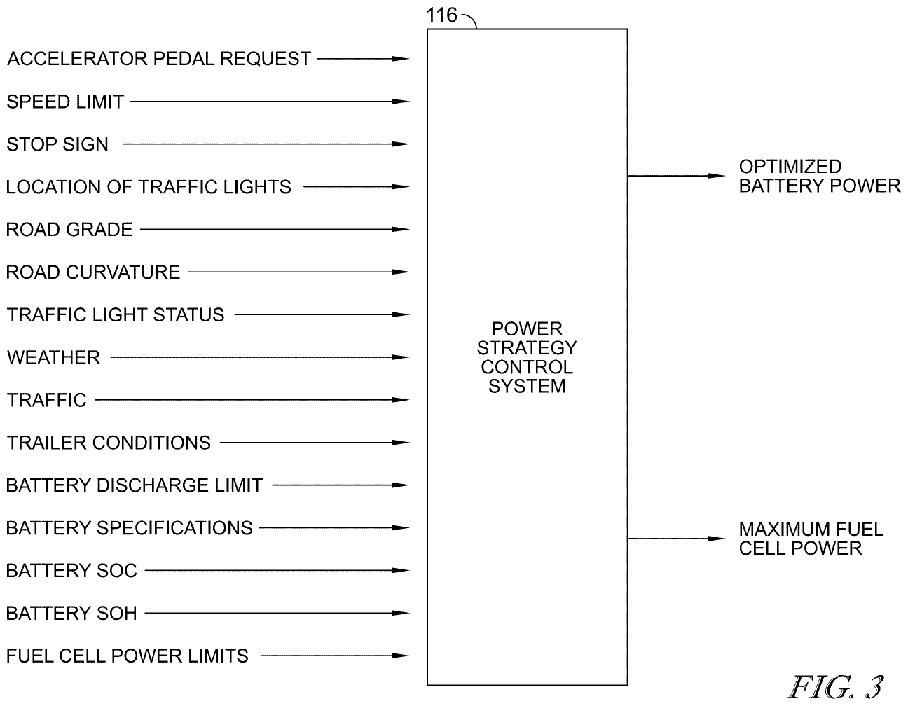

The power strategy control system 116 is communicatively coupled with the fuel cell 112 and the battery 114, as shown in FIG. 2. The power strategy control system 116 is configured to maximize a power availability for the FCEV 100 to fulfill a vehicle power demand. The power strategy control system 116 is configured to determine a maximum fuel cell power from the fuel cell 112 and an optimized battery power from the battery 114 based, at least in part, on a battery discharge limit of the battery 114, an accelerator pedal request, and drive conditions, as shown in FIG. 3. The power strategy control system 116 is configured to control operation of the fuel cell 112 to provide the maximum fuel cell power and the battery 114 to provide the optimized battery power so that the power availability for the FCEV 100 is maximized by the maximum fuel cell power, while the battery 114 is protected from runaway via the optimized battery power.

The power strategy control system 116 is in communication with a battery management system 120, a pedal sensor 122, and at least one conditions sensor 124, as shown in FIG. 2. The power strategy control system 116 receives inputs from each of the battery management system 120, the pedal sensor 122, and/or the conditions sensor 124 in order to determine the maximum fuel cell power from the fuel cell 112 and the optimized battery power from the battery 114.

The present power strategy control system 116 allows for dynamic ramp up of power supplied by the fuel cell 112 so the fuel cell 112 can provide more instantaneous power to the high voltage bus 115, and thus the motor 118, based on the drive cycle and the operator power demand. Further, the power strategy control system 116 dynamically limits a current draw from the battery 114 to safeguard the battery 114 against violations of the specifications of the battery 114. Thus, the power strategy control system 116 dynamically ramps up power from the fuel cell 112 based on discharge limits of the battery 114 and accelerator pedal requests to meet operator power demand in aggressive drive cycles while also maintaining a charge of the battery 114 throughout the drive cycle.

The battery management system 120 is in communication with each of the battery 114 and the power strategy control system 116, as shown in FIG. 2. The battery management system 120 receives inputs from the battery 114. For example, the battery management system 120 receives, determines, and/or calculates in real time a state of charge (SOC) of the battery 114, a state of health (SOH) of the battery 114, a total capacity of the battery 114, and/or a capacity that has been discharged from the battery 114, as defined below. The battery management system 120 also receives inputs related to the specifications of the battery 114.

Using the inputs from the battery 114, the battery management system 120 determines and/or calculates a battery discharge limit in real time. “In real time” refers to the immediate, substantially instantaneous, and/or instantaneous monitoring of the battery 114 during current use of the battery 114, the fuel cell 112, or fuel cell stack, etc. There is minimal, if any, lag, pause, delay, or interruption in monitoring of these components. The phrase “in real time” further refers to at least one of the times of occurrence of the associated events, e.g., the time of measurement and collection of parameters, the time to process the parameters, and/or the time of a system response to the parameters occurring instantaneously or substantially instantaneously. Systems, components, and/or methods operating, functioning, and/or being monitored or assessed in real time are doing so instantaneously or substantially instantaneously (e.g., in the present or current time).

The battery management system 120 communicates the battery discharge limit to the power strategy control system 116, as shown in FIG. 3. The battery management system 120 may also communicate the SOC of the battery 114, the SOH of the battery 114, information regarding the specifications of the battery 114, and/or any other information to the power strategy control system 116. The power strategy control system 116 also receives inputs regarding power limits of the fuel cell 112.

The optimized battery power is determined and limited by the power strategy control system 116 so that the SOH and the SOC of the battery 114 are conserved so as to protect the battery 114 from runaway and to maintain the SOC of the battery 114 in a higher efficiency band. Runaway of the battery 114 may include thermal runaway. Thermal runaway occurs when an internal temperature of the battery rises uncontrollably, as defined in the art. In some embodiments, the higher efficiency band may be defined as the battery 114 having at least 50% of its total charge available. In some embodiments, the higher efficiency band may be defined as the battery 114 having at least 80% of its total charge available. In some embodiments, the higher efficiency band may be defined as the battery 114 having at least 50% to at least 95% of its total charge available, including any specific percentage or range of percentages included therein.

In other words, the battery 114 is operated by the power strategy control system 116 in such a way that violations of the specifications of the battery 114 are reduced and/or prevented, violations of the limits of the battery 114 are reduced and/or prevented, and/or parameters that indicate health operation and/or function of the battery 114 are maintained. The power strategy control system 116 counters derating of the battery 114 in aggressive scenarios as the power strategy control system 116 limits the power draw from the battery 114, while conserving the SOC and life of the battery 114. Derating refers to a lowering of the rated capability of the battery due to deterioration or inadequacy. Thus, the power strategy control system 116 reduces and/or prevents battery 114 degradation during use. In other words, the power strategy control system 116 preemptively counteracts conditions that would derate and/or damage the battery 114 by optimizing the battery power supplied from the battery 114 to the high voltage bus 115 and the motor 118.

The power strategy control system 116 also receives inputs from the pedal sensor 122, as shown in FIG. 2. The pedal sensor 122 is coupled with an accelerator pedal 126 of the FCEV 100. The pedal sensor 122 is in communication with the power strategy control system 116 to provide one or more accelerator pedal request inputs to the power strategy control system 116 in real time, as shown in FIG. 3, based on an acceleration level of the FCEV 100. In other words, the pedal sensor 122 determines how much the accelerator pedal 126 is being pressed by the operator.

In some embodiments, the pedal sensor 122 is a voltage sensor. In such an embodiment, depending on how hard the accelerator pedal 126 is being pressed by the operator, the voltage detected by the pedal sensor 122 varies. In some embodiments, the voltage detected by the pedal sensor 122 may be about 0 V to about 5 V, including any voltage or range of voltages included therein.

The voltage detected by the pedal sensor 122 is used as or used to determine an accelerator pedal request input. The accelerator pedal request input is used to determine how much the accelerator pedal 126 is being pressed or depressed by the operator. In other embodiments, the pedal sensor 122 may be any other suitable sensor.

When the accelerator pedal request is high, the accelerator pedal 126 is being pressed more by the operator (as compared to when the accelerator pedal request is low or not as high). When the accelerator pedal 126 is being pressed more by the operator, the operator is applying more force or pressure to the accelerator pedal 126 than when no, minimal, or limited pressure is being applied by the operator to the accelerator pedal 126. The power strategy control system 116 uses the real-time input of the accelerator pedal request to determine how much power the high voltage bus 115 and the motor 118 (and thus, the FCEV 100) requires. Based on the inputs to the power strategy control system 116 from the pedal sensor 122, the maximum fuel cell power will be increased accordingly.

The power strategy control system 116 also receives one or more real-time inputs from the conditions sensor 124, as shown in FIG. 2. The conditions sensor 124 includes a global positioning system (GPS), vehicle to vehicle infrastructure (V2X), dedicated short range communication (DSRC), ranging sensor, offline maps, online maps, other sensors, and/or any combination of the same. The conditions sensor 124 provides inputs to the power strategy control system 116 including, but not limited to, a speed limit (e.g., 50 MPH, 60 MPH, etc.), one or more locations of stop signs (100 feet ahead, 200 feet ahead, etc.), one or more locations of traffic lights (100 feet ahead, 200 feet ahead, etc.), a traffic light status (e.g., red, yellow, green, function, or nonfunctional), a road grade (e.g., the slope of the road ranging from about 5% to about 50%), one or more road conditions (e.g., wet, hazardous, hills, potholes, debris, construction, etc.), a road curvature (e.g. horizontal or vertical curves often indicated by a length of a radius of the curve), one or more traffic conditions (e.g., heavy traffic, light traffic, medium traffic, and/or traffic obstructions), frequency and/or existence of stop-and-start locations (e.g., stop signs, traffic lights, traffic, etc.), obstacles (construction, road blockages, etc.), weather (e.g., rain, sleet, hail, and/or snow), and/or trailer conditions. For example, trailer conditions include whether the FCEV 100 includes a trailer at all. If so, a weight and/or a size of the trailer, if included.

Illustratively, the conditions sensor 124 detects and/or determines conditions and/inputs external to the fuel cell electric vehicle 100. The conditions sensor 124 helps to ensure that enough power is being provided to the high voltage bus 115 and the motor 118 by the fuel cell 112 during various drive cycles. For example, additional power may be required if the FCEV 100 is traveling up a steep hill or experiencing other challenging road or travel conditions that require additional power. Based on the inputs to the power strategy control system 116 from the conditions sensor 124, the fuel cell power will be increased accordingly to the maximum power allowed by the FCEV.

The optimized battery power from the battery 114 and the maximum fuel cell power from the fuel cell 112 are dynamically varied by the power strategy control system 116 based on inputs from the battery management system 120, the pedal sensor 122, and/or the conditions sensor 124, as shown in FIGS. 2 and 3. Based on the inputs, the optimized battery power from the battery 114 and the maximum fuel cell power from the fuel cell 112 are changed throughout the drive cycle in real time as the inputs change. As such, the power strategy control system 116 adapts to the drive cycle so that the power provided to the high voltage bus 115 and the motor 118 is maximized by the maximum fuel cell power while protecting the health of the battery 114 via the optimized battery power.

In some embodiments, the power strategy control system 116 includes a computing device 150 in communication over a network 152 with other components of the control system 116 including, but not limited to, a controller 154, one or more power sources 156 in the FCEV 100, and other components 180 of the FCEV 100 that determine function and performance.

The computing device 150 may be embodied as any type of computation or computer device capable of performing the functions described herein, including, but not limited to, a server (e.g., stand-alone, rack-mounted, blade, etc.), a network appliance (e.g., physical or virtual), a high-performance computing device, a web appliance, a distributed computing system, a computer, a processor-based system, a multiprocessor system, a smartphone, a tablet computer, a laptop computer, a notebook computer, and a mobile computing device.

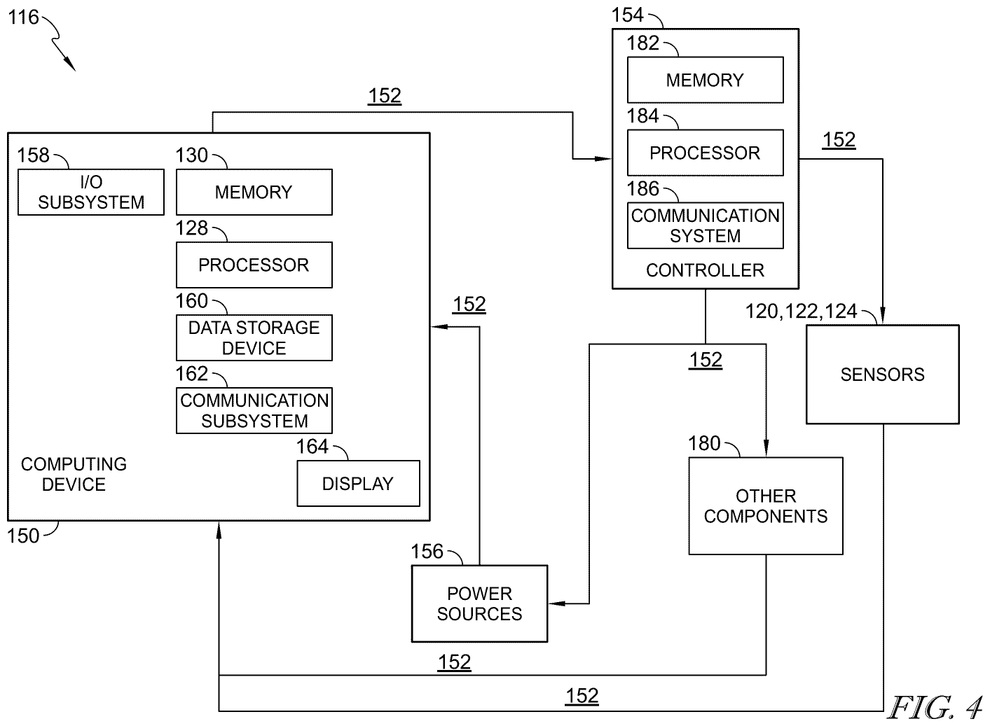

The illustrative computing device 150 of FIG. 4 may include one or more of an input/output (I/O) subsystem 158, a memory 130, a processor 128, a data storage device 160, a communication subsystem 162, and a display 164 that may be connected to each other, in communication with each other, and/or configured to be connected and/or in communication with each other through wired, wireless, and/or power line connections and associated protocols (e.g., Ethernet, InfiniBand®, Bluetooth®, Wi-Fi®, WiMAX, 3G, 4G LTE, 5G, etc.).

The computing device 150 may also include additional and/or alternative components, such as those commonly found in a computer (e.g., various input/output devices). In other embodiments, one or more of the illustrative computing device 150 of components may be incorporated in, or otherwise form a portion of, another component. For example, the memory 130, or portions thereof, may be incorporated in the processor 128.

The processor 128 may be embodied as any type of computational processing tool or equipment capable of performing the functions described herein. For example, the processor 128 may be embodied as a single or multi-core processor(s), digital signal processor, microcontroller, or other processor, or processing/controlling circuit. The memory 130 may be embodied as any type of volatile or non-volatile memory or data storage capable of performing the functions described herein.

In operation, the memory 130 may store various data and software used during operation of the computing device 150 such as operating systems, applications, programs, libraries, and drivers. The memory 130 is communicatively coupled to the processor 128 via the I/O subsystem 158, which may be embodied as circuitry and/or components to facilitate input/output operations with the processor 128, the memory 130, and other components of the computing device 150.

For example, the I/O subsystem 158 may be embodied as, or otherwise include, memory controller hubs, input/output control hubs, sensor hubs, host controllers, firmware devices, communication links (i.e., point-to-point links, bus links, wires, cables, light guides, printed circuit board traces, etc.) and/or other components and subsystems to facilitate the input/output operations.

In one embodiment, the memory 130 may be directly coupled to the processor 128, for example, via an integrated memory controller hub. Additionally, in some embodiments, the I/O subsystem 158 may form a portion of a system-on-a-chip (SoC) and be incorporated, along with the processor 128, the memory 130, and/or other components of the computing device 150, on a single integrated circuit chip (not shown).

The data storage device 160 may be embodied as any type of device or devices configured for short-term or long-term storage of data such as, for example, memory devices and circuits, memory cards, hard disk drives, solid-state drives, or other data storage devices. The computing device 150 also includes the communication subsystem 162, which may be embodied as any communication circuit, device, or collection thereof, capable of enabling communications between the computing device 150 and other remote devices over the network 152.

The components of the communication subsystem 162 may be configured to use any one or more communication technologies (e.g., wired, wireless and/or power line communications) and associated protocols (e.g., Ethernet, InfiniBand®, Bluetooth®, Wi-Fi®, WiMAX, 3G, 4G LTE, 5G, etc.) to effect such communication among and between system components and devices. The controller 154, the power sources 156, the computing device 150, and additional features or components 180 of the FCEV 100 may be connected, communicate with each other, and/or configured to be connected or in communication with each over the network 152 using one or more communication technologies (e.g., wired, wireless and/or power line communications) and associated protocols (e.g., Ethernet, InfiniBand®, Bluetooth®, Wi-Fi®, WiMAX, 3G, 4G LTE, 5G, etc.).

The computing device 150 may also include any number of additional input/output devices, interface devices, hardware accelerators, and/or other peripheral devices. The computing device 150 of the control system 116 of the FCEV 100 may be configured into separate subsystems for managing data and coordinating communications throughout the FCEV 100.

The display 164 of the computing device 150 may be embodied as any type of display capable of displaying digital and/or electronic information, such as a liquid crystal display (LCD), a light emitting diode (LED), a plasma display, a cathode ray tube (CRT), or other type of display device. In some embodiments, the display 164 may be coupled to or otherwise include a touch screen or other input device.

In one embodiment, the optimized battery power and the maximum fuel cell power are generated by the processor 128 based on several inputs, and applied or implemented by the controller 154 to affect the functioning of the FCEV 100. The inputs are provided by the battery management system 120, the pedal sensor 122, and/or the conditions sensor 124. In one embodiment, the optimized battery power and the maximum fuel cell power are generated by the processor 128 based on several inputs, and applied or implemented by the controller 154 in real time and/or automatically to affect the functioning of the FCEV 100. In one embodiment, the controller 154 is in the same computing device 150. In other embodiments, the controller 154 may include a memory 182, a processor 184, and/or a communication system 186, as previously described.

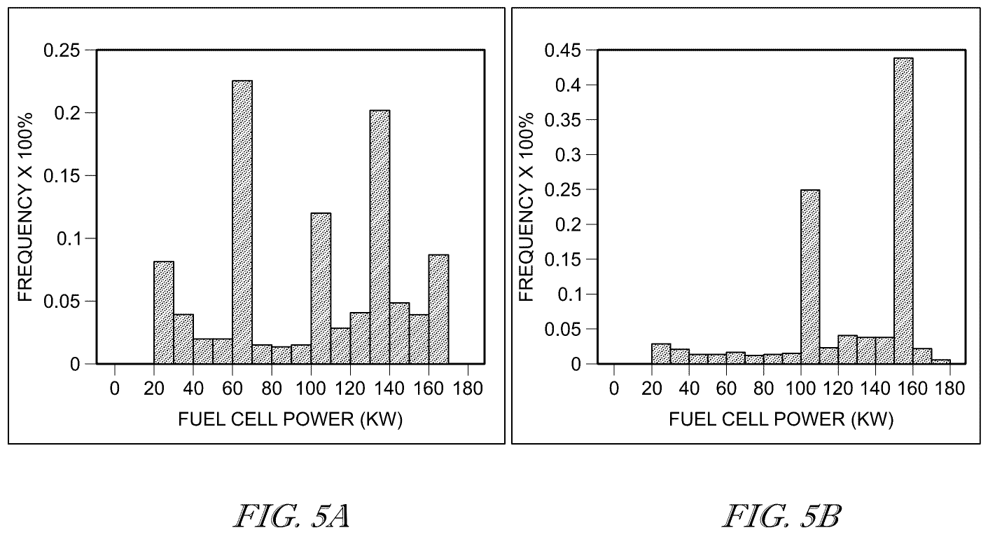

As one example, a FCEV having a traditional control system was compared to the FCEV 100 having the power strategy control system 116. The FCEV 100 having the power strategy control system 116 (see FIG. 5B) had about 46% more power availability to fulfill electrical power demands than the FCEV having the traditional control system (see FIG. 5A).

As shown in FIGS. 5A and 5B, the frequency of high power being delivered to the high voltage bus 115 is greater with the power strategy control system 116 (FIG. 5B) than with the traditional control system (FIG. 5A). With the power strategy control system 116, almost 45% of all power delivered to the high voltage bus 115 is around 160 kW, as compared to only about 10% of power being close to 160 kW in the FCEV having the traditional control system. Thus, the present power strategy control system 116 allows for more power availability to fulfill electrical power demand of the high voltage bus 115 than traditional control systems, which is an unexpected and technical benefit of the present power strategy control system 116 as compared to traditional control systems.

As another example, a diesel vehicle was compared to the FCEV 100 having the power strategy control system 116. The FCEV 100 having the power strategy control system 116 had a 32% improvement in 0-50 miles per hour (mph) acceleration time on flat road conditions as compared to the diesel vehicle. The FCEV 100 having the power strategy control system 116 had a 16% improvement in 0-50 mph acceleration time in on-ramp conditions as compared to the diesel vehicle. Thus, the power strategy control system 116 improves the ability of the FCEV 100 to accelerate as compared to the diesel vehicle since the power strategy control system 116 dynamically ramps up the power provided by the fuel cell 112. This is another unexpected and technical benefit of the present power strategy control system 116 of the FCEV 100 as compared to diesel vehicles.

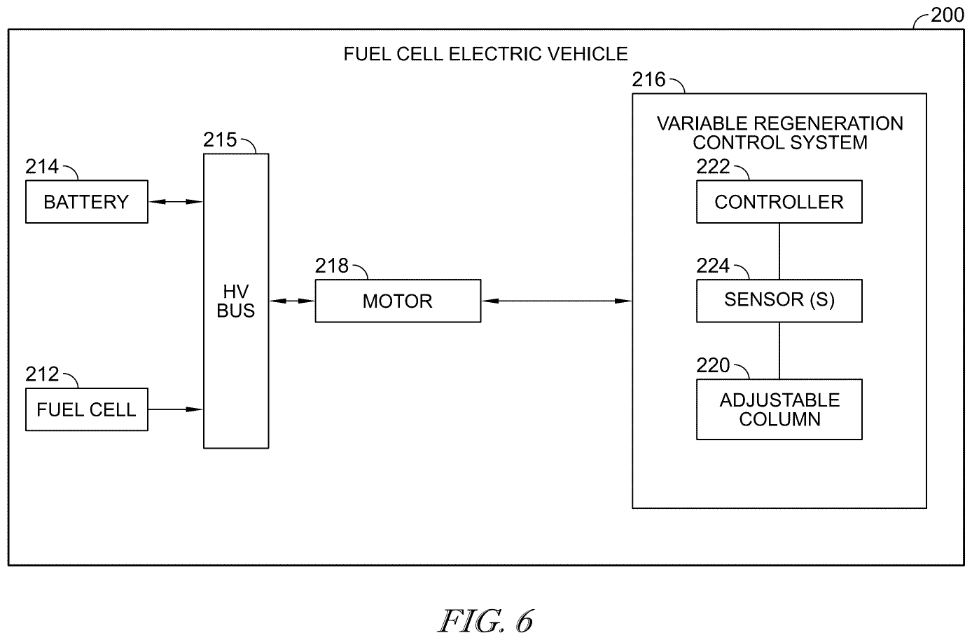

The present disclosure provides a variable regeneration control system 216 for use in a FCEV 200, as shown in FIG. 6. The FCEV 200 includes at least one fuel cell 212, at least one battery 214, a high voltage bus 215, a motor 218, and/or the variable regeneration control system 216. The fuel cell 212 may be the fuel cell 20 described above.

The FCEV 200 has two main power sources, including the at least one fuel cell 212 and the at least one battery 214, as shown in FIG. 6. The fuel cell 212 and the battery 214 provide power to the high voltage bus 215 of the FCEV 200, which powers the motor 218 of the FCEV 200. The fuel cell 212 is configured to charge the battery 214 during different operating states of the FCEV 200. The high voltage bus 215 and the motor 218 are also configured to charge the battery 214 during different operating states of the FCEV 200.

The variable regeneration control system 216 is communicatively coupled with the motor 218, as shown in FIG. 6. The variable regeneration control system 216 is configured to selectively adjust an amount of power provided to the high voltage bus 215 by the motor 218, which is used to charge the battery 214 and/or support power consumption by auxiliary systems while the FCEV 200 is in a coasting mode. In the coasting mode, an accelerator pedal (e.g., the accelerator pedal 126) of the FCEV 200 and/or a brake pedal of the FCEV 200 is not pressed. When operating, the variable regeneration control system 216 is configured to change between at least three different modes (e.g., off, low, medium, and high). In each of the at least three different operating modes, the variable regeneration control system 216 directs the motor 218 (through the high voltage bus 215) to provide a different amount of power to the battery 214 to charge the battery 214.

Illustratively, the variable regeneration control system 216 provides for adjustable regenerative braking levels. Regenerative braking (also referred to as “regen”) is the conversion of kinetic energy of the FCEV 200 into electrical energy stored in the battery 214, which can be used later to power the high voltage bus 215 and/or the motor 218. The variable regeneration control system 216 increases a fuel efficiency of the FCEV 200.

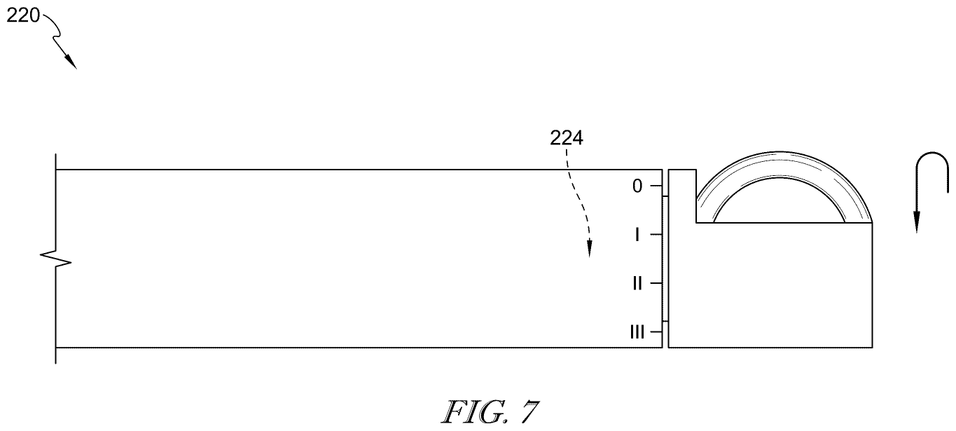

The variable regeneration control system 216 includes an adjustable column 220, a controller 222, and/or at least one sensor 224, as shown in FIG. 6. The adjustable column 220 is located in an interior of the FCEV 200, for example, near a steering wheel, such that the adjustable column 220 is easily accessible by the operator. The adjustable column 220 is configured to be rotated by the operator, as shown in FIG. 7, to move the adjustable column 220 to different positions.

For example, the adjustable column 220 changes between an off position, a first position, a second position, and a third position. Though shown and described as having four positions, the adjustable column 220 may have any number of positions. Further, though shown and described as being rotatable, the adjustable column 220 may change between the different positions via a different method, for example, one or more actuating buttons.

The at least one sensor 224 is coupled with the adjustable column 220 to determine which position the adjustable column 220 is in. For example, if the operator rotates the adjustable column 220 to the first position, the at least one sensor 224 provides a signal to the controller 222 to indicate that the adjustable column 220 is in the first position. The controller 222 is coupled to the at least one sensor 224 to receive a position input therefrom related to the position of the adjustable column 220, and the controller 222 is configured to communicate with the motor 218 based on the position input.

Each of the positions of the adjustable column 220 correspond to a different mode of the variable regeneration control system 216. For example, the off position of the adjustable column 220 corresponds to an off mode of the variable regeneration control system 216. The first position of the adjustable column 220 corresponds to a low mode of the variable regeneration control system 216. The second position of the adjustable column 220 corresponds to a medium mode of the variable regeneration control system 216. The third position of the adjustable column 220 corresponds to a high mode of the variable regeneration control system 216. Each mode of the variable regeneration control system 216 corresponds to a different amount of power being provided to the battery 214 by the motor 218 via the high voltage bus 215. Based on the position of the adjustable column 220 and the mode of the variable regeneration control system 216, the controller 222 communicates with the motor 218 to cause the motor 218 (through the high voltage bus 215) to provide power to the battery 214.

The operator chooses the position of the adjustable column 220 and thus, chooses the mode of the variable regeneration control system 216. The operator may choose a particular mode based on a duty cycle of the FCEV 200. The operator may choose a particular mode based their driving preferences. The operator may choose a particular mode based on the conditions of the drive, the roads, and/or the weather. The operator may choose a particular mode based on many other factors, parameters, or considerations.

If the operator wishes to maximize fuel efficiency, the operator may choose the high mode of the variable regeneration control system 216. For example, while coasting down a steep hill, the operator may choose the high mode of the variable regeneration control system 216. As another example, during start and stop traffic, the operator may choose the low or the medium mode of the variable regeneration control system 216. The variable regeneration control system 216 provides selectable coasting regen levels to maximize regen efficiency of the FCEV 200.

In each mode of the variable regeneration control system 216, the motor 218 (through the high voltage bus 215) is configured to provide up to a maximum (i.e., a peak) coast regen power to the battery 214 via the high voltage bus 215. Thus, the operator sets the maximum coast regen power to be supplied to the battery 214 via the adjustable column 220. An actual power provided to the battery 214 from the motor 218 (through the high voltage bus 215) may be less than the maximum coast regen power. The maximum coast regen power may vary based on a weight of the FCEV 200, the power of the traction system (including the motor 218), the power of the battery 214, and/or the power of the fuel cell 212, among other factors.

While the variable regeneration control system 216 is in the off mode, the motor 218 (through the high voltage bus 215) does not provide power to the battery 214. While the variable regeneration control system 216 is in the low mode, the motor 218 (through the high voltage bus 215) provides up to (e.g., a maximum of) about 25% to about 35% of a total available coast regen power to the battery 214 via the high voltage bus 215, including any specific percentage of power or range of power comprised therein. For example, while the variable regeneration control system 216 is in the low mode, the motor 218 (through the high voltage bus 215) provides up to about 30% of the total available coast regen power to the battery 214 via the high voltage bus 215. Another example, while the variable regeneration control system 216 is in the low mode, the motor 218 (through the high voltage bus 215) provides up to about 33% of the total available coast regen power to the battery 214 via the high voltage bus 215.

While the variable regeneration control system 216 is in the medium mode, the motor 218 (through the high voltage bus 215) provides up to (e.g., a maximum of) about 45% to about 55% of the total available coast regen power to the battery 214 via the high voltage bus 215, including any specific percentage of power or range of power comprised therein. For example, while the variable regeneration control system 216 is in the medium mode, the motor 218 (through the high voltage bus 215) provides up to about 50% of the total available coast regen power to the battery 214 via the high voltage bus 215.

While the variable regeneration control system 216 is in the high mode, the motor 218 (through the high voltage bus 215) provides up to (e.g., a maximum of) about 65% to about 75% of the total available coast regen power to the battery 214 via the high voltage bus 215, including any specific percentage of power or range of power comprised therein. For example, while the variable regeneration control system 216 is in the high mode, the motor 218 (through the high voltage bus 215) provides up to about 70% of the total available coast regen power to the battery 214 via the high voltage bus 215. Another example, while the variable regeneration control system 216 is in the high mode, the motor 218 (through the high voltage bus 215) provides up to about 72% of the total available coast regen power to the battery 214 via the high voltage bus 215.

As an example of the present variable regeneration control system 216 when the total available coast regen power is 180 kW, the maximum coast regen power provided to the battery 214 via the high voltage bus 215 at the low mode is about 60 kW. In such an embodiment, the maximum coast regen power provided to the battery 214 via the high voltage bus 215 at the medium mode is about 90 kW. The maximum coast regen power provided to the battery 214 via the high voltage bus 215 at the high mode is about 132 kW.

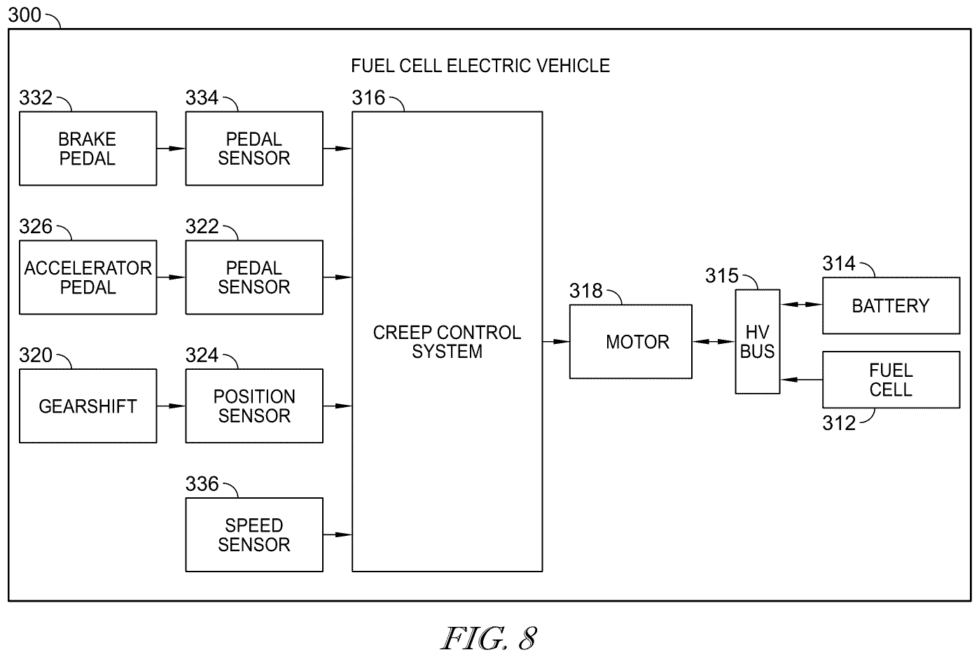

The present disclosure also provides a creep control system 316 for use in a FCEV 300, as shown in FIG. 8. The FCEV 300 includes at least one fuel cell 312, at least one battery 314, a high voltage bus 315, a motor 318, and/or the creep control system 316. The fuel cell 312 may be the fuel cell 20 described above.

The FCEV 300 has two main power sources, including the at least one fuel cell 312 and the at least one battery 314, as shown in FIG. 8. The fuel cell 312 and the battery 314 provide power to the high voltage bus 315 of the FCEV 300, which powers the motor 318 of the FCEV 300. The fuel cell 312 is configured to charge the battery 314 during different operating states of the FCEV 300.

The creep control system 316 is communicatively coupled with the motor 318, the fuel cell 312, and/or the battery 314, as shown in FIG. 8. The creep control system 316 is configured to dynamically adjust an amount of torque provided to the motor 318 while the FCEV 300 is in a creep mode. During creep mode, an accelerator pedal 326 and/or a brake pedal 332 of the FCEV 300 are not pressed by the operator.

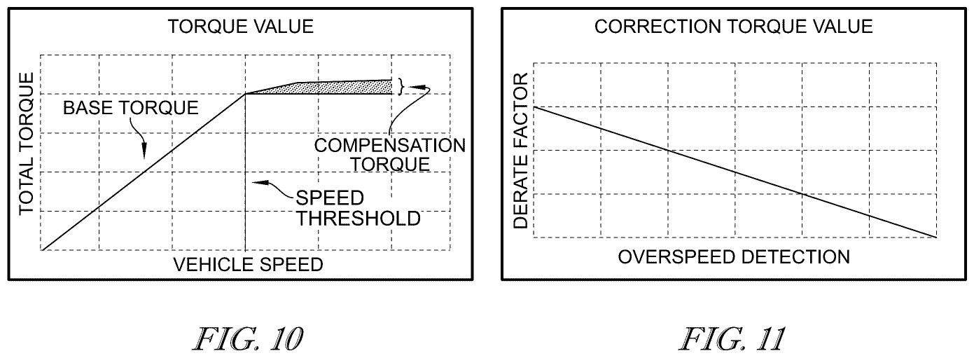

The creep control system 316 is configured to determine a base torque value based, at least in part, on a speed of the FCEV 300. The creep control system 316 is configured to determine a compensation torque value based, at least in part, on the speed of the FCEV 300. The base torque value and the compensation torque value are used to determine a torque value, as shown in FIG. 10. The creep control system 316 is configured to output the torque value so that the motor 318 is provided with the torque value.

The creep control system 316 receives real-time inputs from a brake pedal sensor 334, an accelerator pedal sensor 322, a position sensor 324, and/or a speed sensor 336, as shown in FIG. 8. The brake pedal sensor 334 is coupled with the brake pedal 332 of the FCEV 300. The brake pedal sensor 334 is in communication with the creep control system 316 to provide one or more brake pedal request inputs in real time to the creep control system 316 based on a level of braking of the FCEV 300. In other words, the brake pedal sensor 334 determines how much the brake pedal 332 is being pressed by the operator.

In some embodiments, the brake pedal sensor 334 is a voltage sensor. In such an embodiment, depending on how hard the brake pedal 332 is being pressed by the operator (i.e., how much force or pressure is being applied by the operator), the voltage detected by the brake pedal sensor 334 varies. In some embodiments, the voltage detected by the brake pedal sensor 334 may be about 0 V to about 5 V, including any voltage or range of voltages included therein. The voltage detected by the brake pedal sensor 334 is used as the brake pedal request inputs to the creep control system 316 to determine how much the brake pedal 332 is being pressed or depressed or if the brake pedal 332 is being pressed at all.

The accelerator pedal sensor 322 is coupled with the accelerator pedal 326 of the FCEV 300, as shown in FIG. 8. The accelerator pedal sensor 322 is in communication with the creep control system 316 to provide accelerator pedal request inputs in real time to the creep control system 316 based on an acceleration level of the FCEV 300. In other words, the accelerator pedal sensor 322 determines how much the accelerator pedal 326 is being pressed by the operator.

In some embodiments, the accelerator pedal sensor 322 is a voltage sensor. In such an embodiment, depending on how hard the accelerator pedal 326 is being pressed by the operator, the voltage detected by the accelerator pedal sensor 322 varies. In some embodiments, the voltage detected by the accelerator pedal sensor 322 may be about 0 V to about 5 V, including any voltage or range of voltages included therein. The voltage detected by the accelerator pedal sensor 322 is used as the accelerator pedal request input to the creep control system 316 to determine how much the accelerator pedal 326 is being pressed or depressed or if the accelerator pedal 326 is being pressed at all.

The position sensor 324 is coupled with a gearshift 320 of the FCEV 300, as shown in FIG. 8. The position sensor 324 is in communication with the creep control system 316 to provide one or more gearshift position inputs in real time to the creep control system 316 based on the gear that the FCEV 300 is in. In other words, the position sensor 324 determines if the FCEV 300 is in the gear position of drive, reverse, neutral, or park.

The speed sensor 336 is in communication with the creep control system 316 to provide one or more speed inputs to the creep control system 316 based on the real-time speed of the FCEV 300, as shown in FIG. 8. Illustratively, the creep control system 316 is configured to determine a calibratable torque value used to move the FCEV 300 while the pedals 326, 332 are not engaged. The creep control system 316 determines the torque value so that the FCEV 300 has a smooth transient creep operation. The creep control system 316 has a two stage determination and/or calculation for a requested total torque such that the creep control system 316 ensures a smooth creep speed based on the speed of the FCEV 300 prior to entering the creep mode.

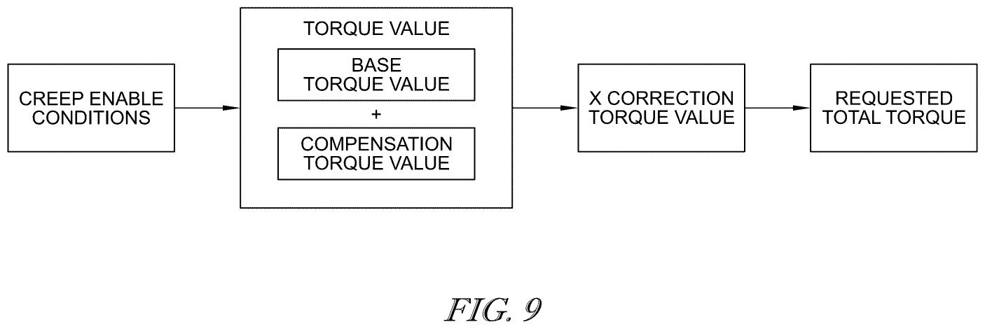

As shown in FIG. 9, the creep control system 316 is activated once creep enabled conditions are met. Creep enabled conditions may include whether and/or how much or frequently/infrequently the brake pedal 332 is being pressed, whether and/or how much or frequently/infrequently the accelerator pedal 326 is being pressed, and/or whether a parking brake is or is not activated. Once the creep control system 316 determines that the FCEV 300 is in the creep mode via inputs from the brake pedal sensor 334, the accelerator pedal sensor 322, and/or the position sensor 324, the creep control system 316 determines the base torque value.

In some embodiments, the base torque value is based solely on the speed of the FCEV 300 as communicated to the creep control system 316 by the speed sensor 336 when the operator's foot is taken off the pedals, 332, 326. As shown in FIG. 10, the base torque value increases as the speed of the FCEV 300 increases. In some embodiments, the base torque value increases linearly at a predetermined rate as the speed of the FCEV 300 increases. If the speed of the FCEV 300 is equal to or greater than a speed threshold of the FCEV 300, as shown in FIG. 10, the base torque value is constant and no longer increases linearly.

If the speed of the FCEV 300 when the operator takes their foot off the pedals 332, 326 is less than the speed threshold, then the torque value is the base torque value as determined by the creep control system 316. If the speed of the FCEV 300 when the operator takes their foot off the pedals 332, 326 is greater than the speed threshold, then the torque value is the base torque value plus a compensation torque value as determined by the creep control system 316. Thus, the compensation torque value is only used in the determination of the torque value if the speed of the FCEV 300 is greater than the speed threshold. In other words, the compensation torque value is zero while the speed of the FCEV 300 is below the speed threshold, and the compensation torque value is greater than zero while the speed of the FCEV 300 is at or above the speed threshold.

Illustratively, the compensation torque value is a proportional-integral-derivative (PID) control mechanism. The creep control system 316 uses feedback to automatically apply accurate corrections to the torque value in real-time, automatically, and/or with minimal to no delay. The compensation torque value helps to reach the required speed of the FCEV 300 in a smooth transition. Thus, while the speed of the FCEV 300 is above the speed threshold, the torque value is the sum of the base torque value and the compensation torque value, as shown in FIGS. 9 and 10. The creep control system 316 outputs the torque value so that the motor 318 is supplied with the torque value while the FCEV 300 is in creep mode.

The creep control system 316 also determines a correction torque value, as shown in FIGS. 9 and 11. The correction torque value is used to smooth out the torque supplied to the motor 318. The correction torque value corrects any sudden overspeed situations. For example, as shown in FIG. 9, the creep control system 316 multiplies the torque value by the correction torque value to determine a requested total torque.

The correction torque value is used when the FCEV 300 begins to speed unexpectedly. For example, if an actual speed of the FCEV 300, as determined using the speed sensor 336, is greater than an expected speed of the FCEV 300 based on the torque value (FIG. 10), then the creep control system 316 determines that the FCEV 300 is not moving (or creeping) as expected and uses the correction torque value.

The correction torque value is determined based on the actual speed of the FCEV 300. In some embodiments, the greater the actual speed of the FCEV 300 as compared to the expected speed (i.e., there is a large difference or delta (4) between the actual and expected speeds), the lower the correction torque value. The lower correction torque value (e.g., 0.5) will impact the torque value more than a higher correction torque value (e.g., 0.9) that is related to a small difference or delta (4) between the actual and expected speeds. The torque value is multiplied by the correction torque value to determine the requested total torque, as shown in FIG. 9. The motor 318 is then supplied with the requested total torque to correct any overspeed situations, and therefore slow the FCEV 300 down.

As shown in FIG. 10, the speed of the FCEV 300 is on the x-axis, and the torque is on the y-axis to determine the total torque. In FIG. 11, an overspeed detection (i.e., a difference between the actual and expected speeds of the FCEV 300) is on the x-axis, and a derate factor is on the y-axis to determine the correction torque value. The total torque, as determined by the creep control system 316 using the graph of FIG. 10, is multiplied by the correction torque value, as determined by the creep control system 316 using the graph of FIG. 11, to determine a requested total torque.

In some embodiments, the creep control system 316 includes a computing device 350 in communication over a network 352 with other components of the control system 316 including, but not limited to, a controller 354, one or more power sources 356 in the FCEV 300, and other components 380 of the FCEV 300 that determine function and performance.

The computing device 350 may be embodied as any type of computation or computer device capable of performing the functions described herein, including, but not limited to, a server (e.g., stand-alone, rack-mounted, blade, etc.), a network appliance (e.g., physical or virtual), a high-performance computing device, a web appliance, a distributed computing system, a computer, a processor-based system, a multiprocessor system, a smartphone, a tablet computer, a laptop computer, a notebook computer, and a mobile computing device.

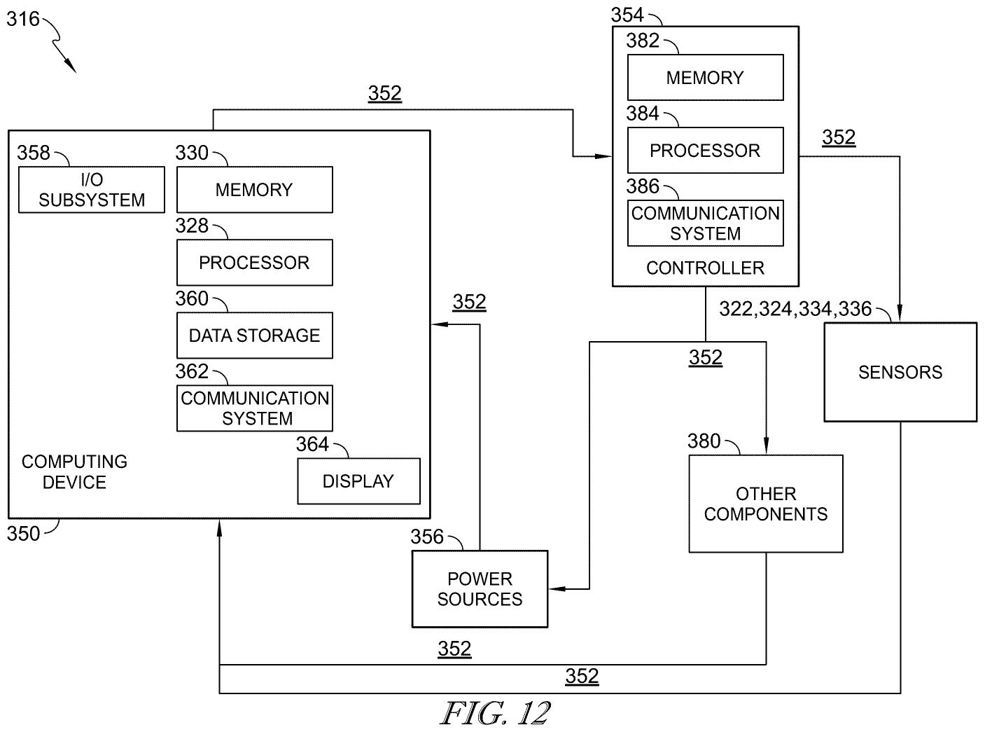

The illustrative computing device 350 of FIG. 12 may include one or more of an input/output (I/O) subsystem 358, a memory 330, a processor 328, a data storage device 360, a communication subsystem 362, and a display 364 that may be connected to each other, in communication with each other, and/or configured to be connected and/or in communication with each other through wired, wireless, and/or power line connections and associated protocols (e.g., Ethernet, InfiniBand®, Bluetooth®, Wi-Fi®, WiMAX, 3G, 4G LTE, 5G, etc.).

The computing device 350 may also include additional and/or alternative components, such as those commonly found in a computer (e.g., various input/output devices). In other embodiments, one or more of the illustrative computing device 350 of components may be incorporated in, or otherwise form a portion of, another component. For example, the memory 330, or portions thereof, may be incorporated in the processor 328.

The processor 328 may be embodied as any type of computational processing tool or equipment capable of performing the functions described herein. For example, the processor 328 may be embodied as a single or multi-core processor(s), digital signal processor, microcontroller, or other processor, or processing/controlling circuit. The memory 330 may be embodied as any type of volatile or non-volatile memory or data storage capable of performing the functions described herein.

In operation, the memory 330 may store various data and software used during operation of the computing device 350 such as operating systems, applications, programs, libraries, and drivers. The memory 330 is communicatively coupled to the processor 328 via the I/O subsystem 358, which may be embodied as circuitry and/or components to facilitate input/output operations with the processor 328, the memory 330, and other components of the computing device 350.

For example, the I/O subsystem 358 may be embodied as, or otherwise include, memory controller hubs, input/output control hubs, sensor hubs, host controllers, firmware devices, communication links (i.e., point-to-point links, bus links, wires, cables, light guides, printed circuit board traces, etc.) and/or other components and subsystems to facilitate the input/output operations.

In one embodiment, the memory 330 may be directly coupled to the processor 328, for example, via an integrated memory controller hub. Additionally, in some embodiments, the I/O subsystem 358 may form a portion of a system-on-a-chip (SoC) and be incorporated, along with the processor 328, the memory 330, and/or other components of the computing device 350, on a single integrated circuit chip (not shown).

The data storage device 360 may be embodied as any type of device or devices configured for short-term or long-term storage of data such as, for example, memory devices and circuits, memory cards, hard disk drives, solid-state drives, or other data storage devices. The computing device 350 also includes the communication subsystem 362, which may be embodied as any communication circuit, device, or collection thereof, capable of enabling communications between the computing device 350 and other remote devices over the network 352.

The components of the communication subsystem 362 may be configured to use any one or more communication technologies (e.g., wired, wireless and/or power line communications) and associated protocols (e.g., Ethernet, InfiniBand®, Bluetooth®, Wi-Fi®, WiMAX, 3G, 4G LTE, 5G, etc.) to effect such communication among and between system components and devices. The controller 354, the power sources 356, the computing device 350, and additional features or components 380 of the FCEV 300 may be connected, communicate with each other, and/or configured to be connected or in communication with each over the network 352 using one or more communication technologies (e.g., wired, wireless and/or power line communications) and associated protocols (e.g., Ethernet, InfiniBand®, Bluetooth®, Wi-Fi®, WiMAX, 3G, 4G LTE, 5G, etc.).

The computing device 350 may also include any number of additional input/output devices, interface devices, hardware accelerators, and/or other peripheral devices. The computing device 350 of the control system 316 of the FCEV 300 may be configured into separate subsystems for managing data and coordinating communications throughout the FCEV 300.

The display 364 of the computing device 350 may be embodied as any type of display capable of displaying digital and/or electronic information, such as a liquid crystal display (LCD), a light emitting diode (LED), a plasma display, a cathode ray tube (CRT), or other type of display device. In some embodiments, the display 364 may be coupled to or otherwise include a touch screen or other input device.

In one embodiment, the base torque value, the compensation torque value, the torque value, the correction torque value, and/or the requested total torque are generated by the processor 328 based on several inputs, and applied or implemented by the controller 354 to affect the functioning of the FCEV 300. The inputs are provided by the pedal sensor 334, the pedal sensor 322, the position sensor 324, and/or the speed sensor 336. In one embodiment, the base torque value, the compensation torque value, the torque value, the correction torque value, and/or the requested total torque are generated by the processor 328 based on several inputs, and applied or implemented by the controller 354 in real time or automatically to affect the functioning of the FCEV 300. In one embodiment, the controller 354 is in the same computing device 350. In other embodiments, the controller 354 may include a memory 382, a processor 384, and a communication system 386, as previously described.

Though the power strategy control system 116, the variable regeneration control system 216, and the creep control system 316 are described as related to different FCEVs 100, 200, 300, the control systems 116, 216, 316 may be combined in any way in one FCEV 100, 200, 300. For example, a FCEV may include both of the power strategy control system 116 and the variable regeneration control system 216, or a FCEV may include all three control systems 116, 216, 316.

Aspects of the disclosed embodiments are also set out in the following set of numbered clauses in which is described:

Clause 1. A fuel cell electric vehicle comprising at least one fuel cell configured to provide power, at least one battery configured to provide power, a motor configured to receive power from the at least one fuel cell and the at least one battery and configured to provide power to the at least one battery to charge the at least one battery, and a variable regeneration control system in communication with the motor and configured to selectively adjust an amount of power provided to the at least one battery by the motor while the fuel cell electric vehicle is in a coasting mode during which an accelerator pedal of the fuel cell electric vehicle is not pressed, the variable regeneration control system configured to change between at least three different modes, the variable regeneration control system in each of the at least three different modes directs the motor to provide a different amount of power to the at least one battery.

Clause 2. The vehicle of clause 1, wherein the variable regeneration control system includes an adjustable column arranged in an interior of the fuel cell electric vehicle, the adjustable column is configured to be rotated by an operator between at least three different positions to change the variable regeneration control system between the at least three modes.

Clause 3. The vehicle of clause 2, wherein each of the at least three different positions correspond to a respective one of the at least three modes of the variable regeneration control system.

Clause 4. The vehicle of clause 2, wherein the variable regeneration control system includes a controller and at least one sensor configured to determine which position of the at least three different positions the adjustable column is in.

Clause 5. The vehicle of clause 4, wherein the controller is coupled to the at least one sensor to receive a position input therefrom related to the position of the adjustable column and the controller is configured to communicate with the motor based on the position input.

Clause 6. The vehicle of clause 2, wherein the at least three different modes of the variable regeneration control system includes a low mode, a medium mode, and a high mode, and wherein the at least three different positions of the adjustable column includes a first position corresponding to the low mode, a second position corresponding to the medium mode, and a third position corresponding to the high mode.

Clause 7. The vehicle of clause 6, wherein, in response to the variable regeneration control system being in the low mode, the motor provides up to about 33% of a total available coast regen power to the at least one battery.

Clause 8. The vehicle of clause 6, wherein, in response to the variable regeneration control system being in the medium mode, the motor provides up to about 50% of a total available coast regen power to the at least one battery.

Clause 9. The vehicle of clause 6, wherein, in response to the variable regeneration control system being in the high mode, the motor provides up to about 72% of a total available coast regen power to the at least one battery.

Clause 10. The vehicle of clause 6, wherein the at least three different modes of the variable regeneration control system further includes an off mode, and wherein the at least three different positions of the adjustable column further includes a fourth position corresponding to the off mode.

Clause 11. The vehicle of clause 10, wherein in response to the variable regeneration control system being in the off mode, the motor does not provide power to the at least one battery.

Clause 12. A method of using a fuel cell electric vehicle comprising: providing power to a motor of the fuel cell electric vehicle via at least one fuel cell and at least one battery, rotating an adjustable column arranged in an interior of the fuel cell electric vehicle to cause the adjustable column to move to a first position, in response to the adjustable column moving to the first position, changing a variable regeneration control system to a first mode, in response to the variable regeneration control system being in the first mode, providing up to a first maximum power to the at least one battery from the motor to charge the at least one battery, rotating the adjustable column to cause the adjustable column to move to a second position different than the first position, in response to the adjustable column moving to the second position, changing the variable regeneration control system to a second mode different than the first mode, and in response to the variable regeneration control system being in the second mode, providing up to a second maximum power to the at least one battery from the motor to charge the at least one battery, the second maximum power being greater than the first maximum power.

Clause 13. The method of clause 12, further comprising rotating the adjustable column to cause the adjustable column to move to a third position different than the first position and the second position.

Clause 14. The method of clause 13, further comprising, in response to the adjustable column moving to the third position, changing the variable regeneration control system to a third mode different than the first mode and the second mode.

Clause 15. The method of clause 14, further comprising, in response to the variable regeneration control system being in the third mode, providing up to a third maximum power to the at least one battery from the motor to charge the at least one battery, the third maximum power being greater than the second maximum power.

Clause 16. The method of clause 15, wherein the first maximum power is about 33% of a total available coast regen power.

Clause 17. The method of clause 15, wherein the second maximum power is about 50% of a total available coast regen power.

Clause 18. The method of clause 15, wherein the third maximum power is about 72% of a total available coast regen power.

Clause 19. The method of clause 12, wherein the variable regeneration control system includes a controller and at least one sensor configured to determine which position the adjustable column is in.

Clause 20. The method of clause 19, wherein the controller is coupled to the at least one sensor to receive a position input therefrom related to the position of the adjustable column and the controller is configured to communicate with the motor based on the position input.

Clause 21. A fuel cell electric vehicle comprising: at least one fuel cell configured to provide power, at least one battery configured to provide power, a motor configured to receive power from the at least one fuel cell and the at least one battery, and a creep control system in communication with the motor and configured to dynamically adjust an amount of torque provided to the motor while the fuel cell electric vehicle is in a creep mode during which an accelerator pedal and a brake pedal of the fuel cell electric vehicle are not pressed, the creep control system configured to determine a base torque value based on a speed of the fuel cell electric vehicle and a compensation torque value based, at least in part, on the speed of the fuel cell electric vehicle to determine a requested total torque, and the creep control system is configured to output the requested total torque so that the motor is provided with the requested total torque.

Clause 22. The vehicle of clause 21, wherein the base torque value is based solely on the speed of the fuel cell electric vehicle.

Clause 23. The vehicle of clause 21, wherein the base torque value increases at a predetermined rate as the speed of the fuel cell electric vehicle increases.

Clause 24. The vehicle of clause 23, wherein the base torque value is constant once a threshold speed of the fuel cell electric vehicle is reached.

Clause 25. The vehicle of clause 24, wherein the compensation torque value is zero while the speed of the fuel cell electric vehicle is below the threshold speed.

Clause 26. The vehicle of clause 25, wherein the compensation torque value is greater than zero while the speed of the fuel cell electric vehicle is at or above the threshold speed.

Clause 27. The vehicle of clause 21, wherein the creep control system is configured to determine a correction torque value based, at least in part, on an actual speed of the fuel cell electric vehicle as compared to an expected speed of the fuel cell electric vehicle based on the requested torque value, and wherein the correction torque value is configured to correct an overspeed condition of the fuel cell electric vehicle.

Clause 28. The vehicle of clause 27, wherein the requested total torque is based, at least in part, on the correction torque value.

Clause 29. A method of determining creep of a fuel cell electric vehicle comprising: determining if the fuel cell electric vehicle is in a creep mode during which an accelerator pedal and a brake pedal of the fuel cell electric vehicle are not pressed, in response to determining that the fuel cell electric vehicle is in the creep mode, determining a base torque value based on a speed of the fuel cell electric vehicle, determining a compensation torque value based, at least in part, on the speed of the fuel cell electric vehicle, determining a requested total torque based on the base torque value and the compensation torque value, and outputting the requested total torque so that a motor of the fuel cell electric vehicle is provided with the requested total torque.

Clause 30. The method of clause 29, wherein the base torque value is based solely on the speed of the fuel cell electric vehicle.

Clause 31. The method of clause 29, wherein the base torque value increases at a predetermined rate as the speed of the fuel cell electric vehicle increases.

Clause 32. The method of clause 31, wherein the base torque value is constant once a threshold speed of the fuel cell electric vehicle is reached.

Clause 33. The method of clause 32, wherein the compensation torque value is zero while the speed of the fuel cell electric vehicle is below the threshold speed.

Clause 34. The method of clause 33, wherein the compensation torque value is greater than zero while the speed of the fuel cell electric vehicle is at or above the threshold speed.

Clause 35. The method of clause 29, further comprising determining a correction torque value based, at least in part, on an actual speed of the fuel cell electric vehicle as compared to an expected speed of the fuel cell electric vehicle based on the requested torque value.

Clause 36. The method of clause 35, wherein the step of determining a requested total torque based on the base torque value and the compensation torque value includes determining the requested total torque based, at least in part, on the correction torque value.

The features illustrated or described in connection with one exemplary embodiment may be combined with any other feature or element of any other embodiment described herein. Such modifications and variations are intended to be included within the scope of the present disclosure. Further, a person skilled in the art will recognize that terms commonly known to those skilled in the art may be used interchangeably herein.

The above embodiments are described in sufficient detail to enable those skilled in the art to practice what is claimed and it is to be understood that logical, mechanical, and electrical changes may be made without departing from the spirit and scope of the claims. The detailed description is, therefore, not to be taken in a limiting sense.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values comprise, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first,” “second,” “third” and the like, as used herein do not denote any order or importance, but rather are used to distinguish one element from another. The term “or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising,” “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps.

The phrase “consisting of” or “consists of” refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about,” and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A fuel cell electric vehicle comprising:
at least one fuel cell configured to provide power for the fuel cell electric vehicle,
at least one battery configured to provide power for the fuel cell electric vehicle, and
a power strategy control system communicatively coupled with the at least one fuel cell and the at least one battery and configured to maximize a power availability for the fuel cell electric vehicle to fulfill a vehicle power demand,
wherein the power strategy control system is configured to:
determine a maximum fuel cell power from the at least one fuel cell and an optimized battery power from the at least one battery based, at least in part, on a battery discharge limit of the at least one battery, an accelerator pedal request, and drive conditions, and
control operation of the at least one fuel cell to provide the maximum fuel cell power and the at least one battery to provide the optimized battery power so that the power availability for the fuel cell electric vehicle is maximized by the maximum fuel cell power while the at least one battery is protected from damage via the optimized battery power.

2. The vehicle of claim 1, wherein the optimized battery power is limited by the power strategy control system so that a state of health and a state of charge of the at least one battery are conserved so as to protect the at least one battery from damage.

3. The vehicle of claim 1, further comprising a battery management system in communication with each of the at least one battery and the power strategy control system, and wherein the battery management system determines the battery discharge limit in real-time based on inputs from the at least one battery and the battery management system communicates the battery discharge limit to the power strategy control system.

4. The vehicle of claim 3, further comprising a pedal sensor coupled with an accelerator pedal of the fuel cell electric vehicle, and wherein the pedal sensor is in communication with the power strategy control system to provide accelerator pedal request inputs to the power strategy control system based on an acceleration level of the fuel cell electric vehicle.

5. The vehicle of claim 4, wherein the drive conditions include road grade and traffic.

6. The vehicle of claim 5, wherein the drive conditions further include trailer conditions of the fuel cell electric vehicle.

7. The vehicle of claim 6, wherein the power strategy control system is in communication with at least one of a global positioning system and a sensor to receive the drive conditions therefrom.

8. The vehicle of claim 1, further comprising a voltage sensor coupled with an accelerator pedal of the fuel cell electric vehicle, and wherein the voltage sensor is in communication with the power strategy control system to provide accelerator pedal request inputs to the power strategy control system based on an acceleration level of the fuel cell electric vehicle.

9. A fuel cell electric vehicle comprising:
at least one fuel cell configured to provide power for the fuel cell electric vehicle,
at least one battery configured to provide power for the fuel cell electric vehicle, and
a power strategy control system communicatively coupled with the at least one fuel cell and the at least one battery and configured to maximize a power availability for the fuel cell electric vehicle to fulfill a vehicle power demand,
wherein the power strategy control system is configured to determine a maximum fuel cell power from the at least one fuel cell and an optimized battery power from the at least one battery based on a battery discharge limit of the at least one battery, an accelerator pedal request, and drive conditions.

10. The vehicle of claim 9, wherein the optimized battery power is limited by the power strategy control system so that a state of health and a state of charge of the at least one battery are conserved so as to protect the at least one battery from damage.

11. The vehicle of claim 9, further comprising a battery management system in communication with each of the at least one battery and the power strategy control system, and wherein the battery management system determines the battery discharge limit in real-time based on inputs from the at least one battery and the battery management system communicates the battery discharge limit to the power strategy control system.

12. The vehicle of claim 11, further comprising a sensor coupled with an accelerator pedal of the fuel cell electric vehicle, and wherein the sensor is in communication with the power strategy control system to provide accelerator pedal request inputs to the power strategy control system based on an acceleration level of the fuel cell electric vehicle.

13. The vehicle of claim 12, wherein the drive conditions include road grade and traffic.

14. The vehicle of claim 13, wherein the power strategy control system is in communication with at least one of a global positioning system and a sensor to receive the drive conditions therefrom.

15. A method of maximizing a power availability for a fuel cell electric vehicle to fulfill a vehicle power demand, the method comprising:
receiving a battery discharge limit from a battery management system based on at least one battery of the fuel cell electric vehicle,
receiving an accelerator pedal request related to an acceleration level of the fuel cell electric vehicle,
receiving drive conditions,
based on the battery discharge limit of the at least one battery, the accelerator pedal request, and the drive conditions, determining a maximum fuel cell power from at least one fuel cell and an optimized battery power from the at least one battery,
controlling operation of the at least one fuel cell to provide the maximum fuel cell power to a motor of the fuel cell electric vehicle so that the power availability for the fuel cell electric vehicle is maximized by the maximum fuel cell power, and
controlling the at least one battery to provide the optimized battery power to the motor so that the at least one battery is protected from damage via the optimized battery power.

16. The method of claim 15, further comprising receiving a state of health and a state of charge of the at least one battery to determine the battery discharge limit.

17. The method of claim 15, wherein the step of receiving an accelerator pedal request includes detecting voltage data related to the acceleration level of the fuel cell electric vehicle via a sensor coupled with an accelerator pedal.

18. The method of claim 15, wherein the drive conditions include road grade and traffic.

19. The method of claim 18, wherein the drive conditions further include trailer conditions of the fuel cell electric vehicle.

20. The method of claim 18, further comprising detecting the drive conditions via at least one of a global positioning system and a sensor.
